(19) United States
(12) Patent Application Publication
(10) Pub. No.: US 2023/0086292 A1
(43) Pub. Date: Mar. 23, 2023

(54) COUPLINGS AND CONNECTORS FOR CABLES

(71) Applicant: Hubbell Limited, London (GB)

(72) Inventors: Carl Jackson, Greater Manchester (GB); Lawrence Murray Lonergan, Greater Manchester (GB); Gareth Turner, Greater Manchester (GB)

(21) Appl. No.: 17/798,766

(22) PCT Filed: Feb. 10, 2021
(86) PCT No.: PCT/GB2021/050304

§ 371 Date: Aug. 10, 2022

(30) Foreign Application Priority Data
Feb. 10, 2020 (GB) 2001787.7

(51) Int. Cl. H01R 13/622; H01R 13/405; H01R 13/52; H01R 13/74; H01R 4/28

(52) U.S. Cl. CPC H01R 13/622; H01R 13/405; H01R 13/5205; H01R 13/74; H01R 4/28

(57) ABSTRACT

A coupling (1) comprising: a first part (2) sized and shaped to fit through an orifice in a surface and having a mounting surface (5) for abutting against the surface, and comprising a body having a through bore (7); and a first connector part (13) having a termination (15) for at least one conductor, and a connection member (16) for each termination (15); and a second part (3) in threaded engagement with the first part (2), the second part comprising a body having a through bore (10) in communication with the through bore (7) of the first part (2); a second connector part (14) having a connection member (17) complementary to each connection member (16) of the first connector part (13) so that the connection members (16, 17) of the first (13) and second (14) connector parts can engage each other and a termination (19) for a conductor for each connection member (16) of the second connector part (3).

This invention relates to couplings and connectors for cables, and related methods.

Cable glands are commonly used for sealing around a cable or conduit passing through an opening in a wall or bulkhead. For example, cable gland assemblies may be used to seal around a cable entering an enclosure such as a junction box, containing electrical equipment, to prevent fluids entering the enclosure or explosive forces exiting the enclosure. In some instances, cable glands can be used in harsh environments, such as underwater, in high temperatures, or harsh chemical environments.

Typically, a cable gland includes a body, through which the cable passes. The body is formed of a number of parts, that are fixed together to assemble the gland. Each joint can provide a source of leakage. A clamp to grip the cable, and prevent it being pulled out of the gland is provided in the body, along with a number of seals.

Cable glands for hazardous areas incorporate armour clamps to ensure that the wire armour or braid in the cable effectively forms a conductive bond with the body of the gland. Typically, a middle nut of the gland is used as a vice against the entry of the gland to compress an armour clamp against the gland spigot with the armour or braid sandwiched between, forming a mechanical bond. This is generally done when the entry of the gland is already mounted to an enclosure. When the gland is mounted to a luminaire, the luminaire is often in a difficult to reach (elevated) position, making it inappropriate to use a gland of this type. Furthermore, it is necessary to have access to the inside of the apparatus such as the luminaire, which goes against a desire to have such units factory sealed.

According to a first aspect of the invention, there is provided a coupling comprising:
a first part sized and shaped to fit through an orifice in a surface and having a mounting surface for abutting against the surface, and comprising:
   a body having a through bore; and
   a first connector part having a termination for at least one conductor,
   and a connection member for each termination; and
a second part in threaded engagement with the first part, the second part comprising:
   a body having a through bore in communication with the through bore of the first part;
   a second connector part having a connection member complementary to each connection member of the first connector so that the connection members of the first and second connector parts can engage each other and a termination for a conductor for each connection member of the second connector part.

As such, this provides for a coupling that can be used where a cable gland would otherwise be used; the first part can potentially be wired up (that is, the conductors attached to the terminations) and fixed to the surface separately from the wiring up of the second part, with the first and second parts subsequently being connected together.

The first connector part may be positioned within the through bore of the body of the first part. The first connector part may fill the entire cross section of the through bore along a portion of a length of the through bore, and may act to seal the through bore.

The second connector part may be positioned within the through bore of the body of the second part. The second connector part may fill the entire cross section of the through bore along a portion of a length of the through bore, and may act to seal the through bore.

The second part may comprise a cable clamp for a cable, and optionally also an armour clamp for the armour of a cable. The second part may comprise a seal for sealing the second part against a cable in its through bore. The cable clamp may be arranged so as to increase a clamping force on the cable when a rotatable part of the second part is rotated relative to the body. Rotation of the rotatable part may also cause a clamping force of the armour clamp on the armour of the cable to increase.

The body of the second part may comprise a threaded engagement by means of which the second part threadedly engages the first part.

According to a second aspect of the invention, there is provided a first coupling part, sized and shaped to fit through an orifice in a surface and having a mounting surface for abutting against the surface, and comprising:
a body having a through bore; and
a connector part having a termination for at least one conductor, and a
connection member for each termination arranged to engage a complementary connection member of a complementary coupling part;

in which the coupling part has a threaded engagement portion for engaging a complementarily threaded part of the complementary coupling part.

The connector part may be positioned within the through bore of the body of the first part. The connector part may fill the entire cross section of the through bore along a portion of a length of the through bore, and may act to seal the through bore.

The first coupling part may be provided with a clamping means for clamping it against the surface, typically against an opposing side of the surface from which the mounting surface abuts against. The clamping means may, for example, comprise a threaded nut working on an externally threaded part of the body.

The first coupling part may be provided with a removable cap which allows for the closure of the first coupling part without being coupled to a complementary coupling part. Typically, the removable cap may engage the threaded engagement portion.

According to a third aspect of the invention, there is provided a second coupling part, comprising:
a body having a through bore in communication with the through bore of the first part;
a connector part having a at least one connection member each connectable to complementary connection member of a complementary coupling portion and a termination for a conductor for each connection member;
a threaded engagement portion for engaging with a complementary threaded engagement portion of the complementary coupling portion.

The connector part may be positioned within the through bore of the body. The connector part may fill the entire cross section of the through bore along a portion of a length of the through bore, and may act to seal the through bore.

The second coupling part may comprise a cable clamp for a cable, and optionally also an armour clamp for the armour of a cable. The second coupling part may comprise a seal for sealing the second part against a cable in its through bore. The cable clamp may be arranged so as to increase a clamping force on the cable when a rotatable part of the second coupling part is rotated relative to the body. Rotation of the rotatable part may also cause a clamping force of the armour clamp on the armour of the cable to increase.

According to a fourth aspect of the invention, there is provided an electrical apparatus, comprising a housing having at least one wall, a wall of the housing having a surface with an orifice therein, the electrical apparatus further comprising the first coupling part of the second aspect of the invention, or the first part of the coupling of the first aspect of the invention, mounted therein.

By providing just the first coupling part, typically at manufacture, an electrical apparatus can be provided with the means for wiring a cable into it without having to install a cable gland after the electrical apparatus has been installed in its desired location. The first part can be “factory fitted”, which allows the housing to be entirely sealed to the elements. Typically, the removable cap would be provided on the first coupling part.

Once the electrical apparatus with the first coupling part has been installed in the desired location, the second coupling part (whether the remainder of the coupling of the first aspect, or the second coupling part of the third aspect) can be connected and threadedly engaged with the first coupling part.

According to a fifth aspect of the invention, there is provided a connector for connecting to a first connector and a second connector, each of the first and second connections comprising at least one connector member,
the connector comprising:
a body having a through bore from a first end to a second end, threaded engagements at the first end and the second end, and
a connector part in the through bore containing a first connection facing the first end of the through bore and a second connection facing the second end of the through bore,

the first connection comprising, for each connector member of the first connector, a connection member complementary to the connection member of the first connection, the second connection comprising, for each connector member of the second connector, a connection member complementary to the connection member of the second connection.

As such, this provides for a connector that be used to connect two other connectors. This is useful in the case, for example, where a first apparatus has already been provided in a location and has been wired up using a first connector. If it is desired to replace the first apparatus with a second apparatus of a different size, this connector can be used to bridge the gap between the pre-existing wiring and/or connector and the new second apparatus.

The connector part may be positioned within the through bore of the body. The connector part may fill the entire cross section of the through bore along a portion of a length of the through bore, and may act to seal the through bore.

According to a sixth aspect of the invention, there is provided a connection, comprising the connector of the fifth aspect of the invention and, coupled to each of at least one of the first end and the second end, a coupling part selected from the first connector part of the second aspect of the invention and the second coupling part of the third aspect of the invention. Each coupling part may form the first connector and/or the second connector.

According to a seventh aspect of the invention, there is provided a method of installing a coupling, the method comprising:
fitting a first connector part through an orifice in a surface of a housing of an electrical apparatus and a mounting it on that surface, the first connector part having a body having a through bore and a first connection part having a termination for at least one conductor, and a connection member for each termination;
connecting an electrical connection of the electrical apparatus to each termination;
terminating a cable in a second connector part comprising a body having a through bore, a second connection part having a connection member complementary to each connection member of the first connector part so that the connection members of the first and second connector parts can engage each other and a termination for a conductor for each connection member of the second connector part, which a conductor of the cable being terminated in each termination; and
connecting the first connector part to the second connector part so as to threadedly engage each other and such that the connection members of the first and second connector parts electrically connect.

As such, the first part can be installed in an apparatus at the point of manufacture, the second connector connected at a different time, and the two parts connected together as and when convenient. This is more efficient than having to couple a cable gland through the surface of the housing of an apparatus once the apparatus is installed, and removed the need to access the interior of the housing of the apparatus whilst attaching the cable gland.

The step of terminating the cable in the second connector part may comprise clamping armour of the cable in an armour clamp of the second connector part. It may also comprise clamping and/or sealing the cable in the second connector part. Thus, the armour can be “made off” before the two parts are connected together.

Any of the optional features of the above aspects may be applicable to any of the other aspects. The apparatus of the second and third aspects may together form a coupling of the first aspect of the invention. The seventh aspect of the invention may result in a coupling in accordance with the first aspect of the invention.

In all of the aspects discussed above, each of the bodies may comprise a metallic material, such as brass.

There now follows, by way of example only, description of embodiments of the present invention, described with respect to the accompanying drawings, in which:

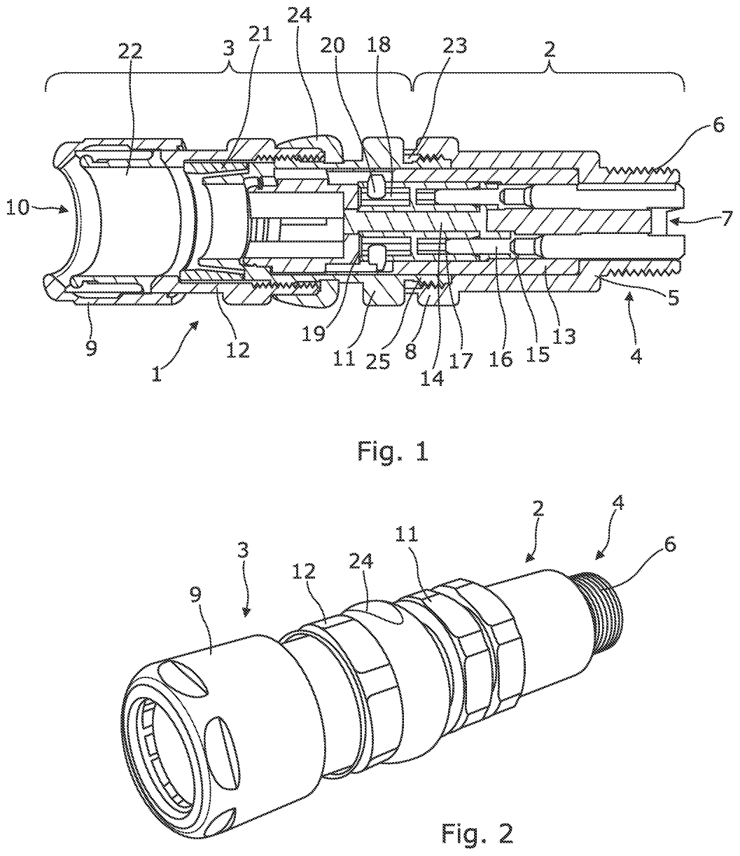

FIG. 1 shows a cross section through a coupling in accordance with a first embodiment of the invention;

FIG. 2 shows a perspective view of the coupling of FIG. 1;

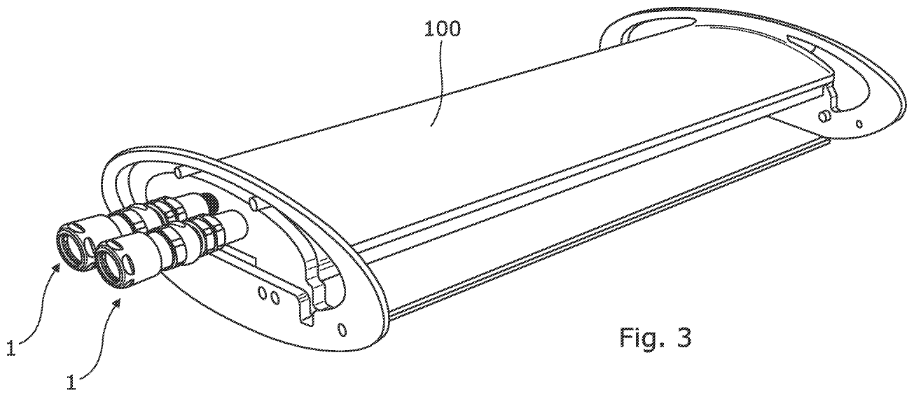

FIG. 3 shows an electrical apparatus installed with the coupling of FIG. 1;

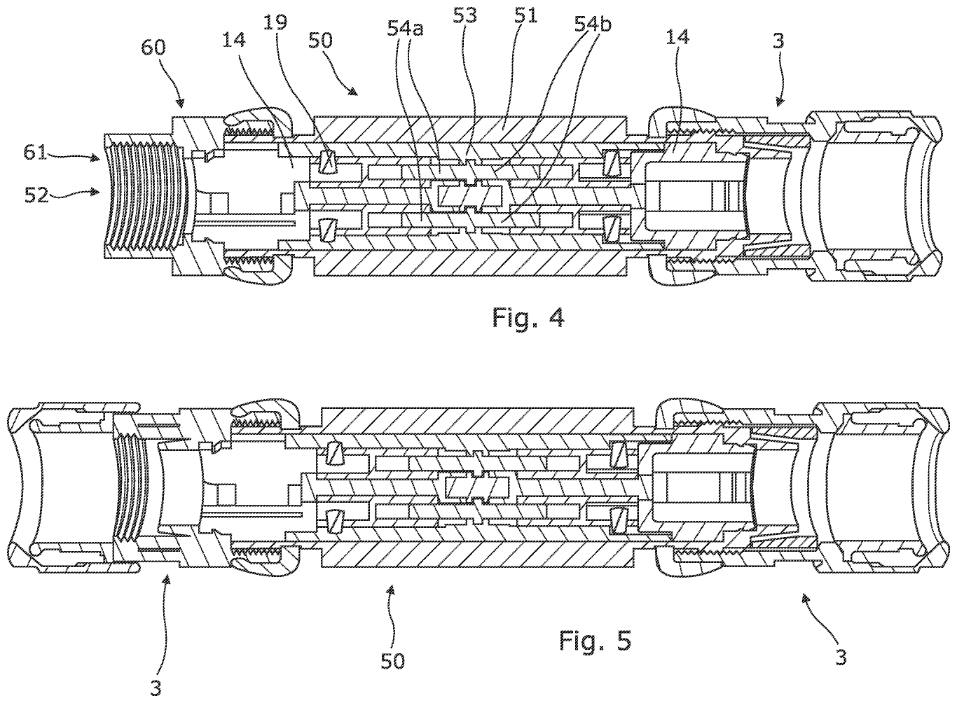

FIG. 4 shows a cross section through a connector in accordance with a second embodiment of the invention;

FIG. 5 shows a cross section through the connector of FIG. 4, in an alternative configuration;

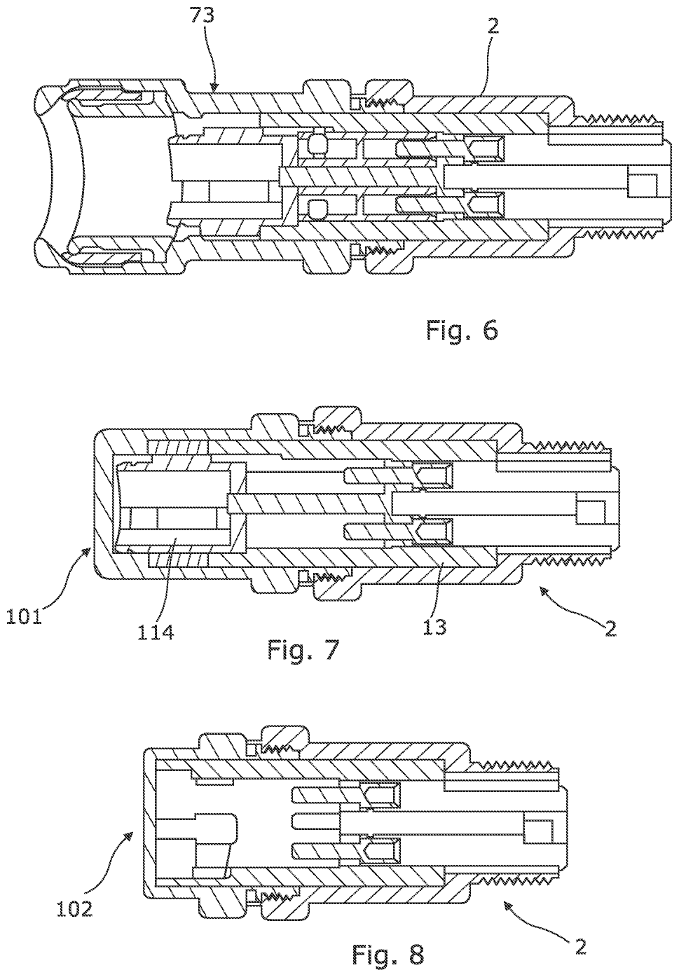

FIGS. 6 to 8 show cross sections through further components for use with the above embodiments.

FIGS. 1 and 2 show a coupling 1 in accordance with a first embodiment of the invention. This coupling will be predominantly for hazardous area equipment, where there is a need for that equipment to be sealed for life. It can also be used if there is a need to terminate cables outside of the equipment, which could reduce the amount of equipment rated for explosive atmospheres, such as the terminal enclosure. Cable terminations are carried out via and internal screwed terminal insert and crimped pin arrangement, therefore eliminating the need to access the equipment.

Connecting the cable cores this way also reduces the need for a cable gland, as the armour clamping arrangement and IP seal are built into the product, eliminating the need for glands and an enclosure.

This coupling 1 comprises a first part 2 and a second part 3.

The first part 2 is an entry part, formed of a generally cylindrical brass body, having a through bore 7 formed therethrough. The body has, at one end (the right-hand end of FIG. 1) an entry portion 4 sized to fit within an orifice in the housing of an item to which the coupling is to be coupled (for example, the luminaire 100 shown in FIG. 3 of the accompanying drawings). The entry portion 4 passes into the interior of such a housing, with a flange 5 abutting against the outer surface of the housing. A nut (not shown) can work on a threaded portion 6 of the entry portion 4, so as to capture the surface between the flange 5 and the nut, so as to secure the first part 2 relative to the housing. The body of the first part 2 extends away from the entry portion and terminates with an internally threaded section 8.

The second part 3 is also formed of a generally cylindrical brass body, with a through-bore 10 therethrough. Starting with the right-most end as shown in FIG. 1, the body starts with an externally threaded portion 25 which engages the internally threaded section 8 of the first part 2. The body itself is formed of three parts, a first body part 11 (of the form of a centre nut) which engages the first part 2, a second body part 12 (of the form of a middle nut) which engages the first body part 11, and a third body part 9 (of the form of a back nut) which engages the second body part 12.

The through bores 7, 10 are in communication and in effect form a common through bore. Within the through bores 7, 10, there is provided a first connector insert 13 within the first part 2 and a second connector insert 14 within the second part 3. In both cases, these plastic inserts fill the through bores 7, 10 (and can act to seal the through bores 7, 10).

The first connector insert 13 comprises, in this particular embodiment, four crimped terminals 15 for conductors within the housing (only two being shown in cross section in FIG. 1). Each of these terminals 15 can be crimped onto a corresponding conductor; typically, this would be done on manufacture of the apparatus. The terminals 15 each connect electrically to a corresponding conductive pin 16 formed in the first connector insert 13.

The second connector insert 14 has a corresponding socket 17 for each pin 16. Each socket 17 is connected to a screw terminal 19 for terminating a conductor (being a conductor of a cable (not shown) passing through the through bore 10). Each screw terminal 19 comprises a blind bore 18 in the second connector insert 14 and a corresponding grub screw 20 which engages and retains a conductor in the blind bore 18. Each socket 17 is electrically connected to the corresponding screw terminal 19.

As such, the pins 16 are a complementary fit in the corresponding sockets 17. Thus, when the pins 16 are engaged in the sockets 17, the conductors in the crimped terminals 15 will be in electrical connection with the conductors of the cable in the through bore 10. The second connector insert 14 is a sliding fit within the first connector insert 13, with the pins of the first connector insert 13 in turn fitting within sockets 17.

The remainder of the second part 3 functions as a standard barrier cable gland, and shares much of its functionality (and indeed, its components) with the gland described in our earlier PCT application published as WO2019/220146. As such, the gland comprises an armour clamp 21 for clamping the armour of a cable, and a clamp and/or seal 22 (an ingress protection or “IP” seal) for the outer surface of the cable. The operative clamping force of both of these features can be driven by rotation of the third body part 9 relative to the second body part 12, the third body part 9 (operating as a back nut) being threadingly engaged on the second body part 12. The operation of these features are described in more reference in our earlier PCT application as referenced above in this paragraph, which is hereby incorporated by reference.

An O-ring 23 provides a seal between the first and second parts 2, 3. A deluge boot 24 provides a seal between the first body part 11 and the second body part 12.

As such, in use the first part 2 can be pre-installed (“in the factory”) to an apparatus such as the luminaire 100 shown in FIG. 3 of the accompanying drawings. Appropriate electrical connections are made to the crimped terminals.

The first part can at this point be provided with a cap 101, 102 as shown in FIG. 7 or 8 of the accompanying drawings, to arrive at the situation shown in FIG. 3 of the accompanying drawings. In a first embodiment, this cap 101 comprises a second connector insert 114 which engages the first connector insert 13 but with no connecting sockets or terminations, but which will allow for the safe capping of the first part should it be energised with electricity. In an alternative embodiment, the cap 102 in FIG. 8 of the accompanying drawings can be used, which simply physically caps the first part 2 if the first part 2 is not going to be energised. In both cases, the caps 101, 102 engage the internally threaded portion 8.

Separately, the cable which is to supply or otherwise connect to the apparatus can be connected to the second part 3. The cable can be stripped down, with the outer armour being clamped in the armour clamp and the insulation around the individual cores stripped away. Each core can be connected to the appropriate screw terminals, and the second part sealed against the outer surface of the cable.

Once the apparatus 100 is installed in the desired location, the second part 3 can be offered up to the (uncapped) first part 2 and connected together. The pins 16 will engage the sockets 17 and the second part screwed into the internally threaded portion 8. As such, there is no need for any access inside the housing of the apparatus

A further connector 50 is shown in FIGS. 4 and 5 of the accompanying drawings. This connector 50 is useful where there is a need for extra distance from an existing connection. For example, there may be a need to install a new piece of equipment in an existing facility where the originally installed cable is not sufficiently long enough to reach the new equipment position. An example of this would be to replace a 4 ft (120 cm) fitting with a shorter unit 2 ft (60 cm) unit. This connector could be supplied with either the second part 3 of the first embodiment at either end (as shown in FIG. 5), or the second part 3 of the first embodiment at one end, and a threaded entry at the other (as shown in FIG. 4) to accommodate a pre-existing gland already fitted to the cable.

As such, the connector comprises a generally cylindrical brass body 51 having a through bore 52. Each end of the body 51 is externally threaded.

Inside the through bore 52 there is provided a plastic insert 53. This has four pairs of conductive pins 54a, 54b, with each pair being electrically connected, and the pins of each pair facing in opposing directions, one towards one end of the bore 52 and the other to the other end, the pins being overmoulded in the plastic insert 53. As such, each face of the insert allows for the connection of the second connector insert 14 of the first aspect of the invention.

This allows for the connection, at either face, of the second part 3 of the connector of FIGS. 1 and 2. This is depicted at both ends of the connector 50 in FIG. 5 of the accompanying drawings, and at the right-most end in FIG. 4.

As an alternative, the left-hand end of FIG. 4 is shown as having an adaptor 60 installed. This adaptor 60 allows for a pre-installed cable gland to be connected to the connector 50, as the adaptor has a through bore 61 which presents an internal thread complementary to the external thread that would typically be present on the entry portion of a pre-existing cable gland (in this case, an M20 thread). The adaptor 60 is also provided with a second connector insert 14 as described with reference to the first embodiment; this allows for the termination of conductive cores from a pre-existing cable gland.

As such, this connector 50 can be used in the situation where the cable to be connected already has a gland on one end; as such, the gland could simply be connected into the adaptor 60 of FIG. 4, with the other end of the connector 50 being connected to the desired apparatus and the cores terminated in the screw terminals 19 of the second connector insert 14 of the adaptor. If the cable does not already have a gland installed, it is simple to connect a second part 3 to the cable as discussed above, and then to mate that with the connector 50.

Alternative second parts possible, such as the non-armoured second part 73 shown in FIG. 6 of the accompanying drawing. This functions as for the second part 3 discussed above, save that it lacks the armour clamping (and as such would be used with non-armoured cable).

Clearly, whilst the examples above have been described with reference to four pins/sockets, any number is possible as long as the respective first and second connector parts are complementary. The connector can be used with any desired apparatus in any desired location.

1. A coupling comprising:
a first part sized and shaped to fit through an orifice in a surface and having a mounting surface for abutting against the surface, and comprising:
a body having a through bore; and
a first connector part having a termination for at least one conductor, and a connection member for each termination; and
a second part in threaded engagement with the first part, the second part comprising:
a body having a through bore in communication with the through bore of the first part;
a second connector part having a connection member complementary to each connection member of the first connector so that the connection members of the first and second connector parts can engage each other and a termination for a conductor for each connection member of the second connector part.

2. The coupling of claim 1, in which at least one of the body of the first part and the body of the second part comprise a metallic material, such as brass.

3. The coupling of claim 1, in which the second part comprises an armour clamp for armour of a cable.

4. The coupling of claim 1, in which the second part comprises a cable clamp for a cable.

5. The coupling of claim 1, in which the first connector part is positioned within the through bore of the body of the first part and may fill the entire cross section of the through bore along a portion of a length of the through bore.

6. The coupling of claim 1, in which the second connector part is positioned within the through bore of the body of the second part and may fill the entire cross section of the through bore along a portion of a length of the through bore.

7. The coupling of claim 1, in which the second part comprises a seal for sealing the second part against a cable in its through bore.

8. The coupling of claim 1, in which the body of the second part comprises a threaded engagement by means of which the second part threadedly engages the first part.

9. A first coupling part, sized and shaped to fit through an orifice in a surface and having a mounting surface for abutting against the surface, and comprising:
a body having a through bore; and
a connector part having a termination for at least one conductor, and a connection member for each termination arranged to engage a complementary connection member of a complementary coupling part;
in which the coupling part has a threaded engagement portion for engaging a complementarily threaded part of the complementary coupling part.

10. The first coupling part of claim 9, provided with a clamping means for clamping it against the surface, typically against an opposing side of the surface from which the mounting surface abuts against.

11. The first coupling part of claim 9, provided with a removable cap which allows for the closure of the first coupling part without being coupled to a complementary coupling part.

12. A second coupling part, comprising:
a body having a through bore in communication with the through bore of the first part;
a connector part having a at least one connection member each connectable to complementary connection member of a complementary coupling portion and a termination for a conductor for each connection member;
a threaded engagement portion for engaging with a complementary threaded engagement portion of the complementary coupling portion.

13. An electrical apparatus, comprising a housing having at least one wall, a wall of the housing having a surface with an orifice therein, the electrical apparatus further comprising a first coupling part sized and shaped to fit through the orifice and comprising:
a body having a through bore; and
a connector part having a termination for at least one conductor, and a connection member for each termination arranged to engage a complementary connection member of a complementary coupling part;
in which the coupling part has a threaded engagement portion for engaging a complementarily threaded part of the complementary coupling part.

14. A connector for connecting to a first connector and a second connector, each of the first and second connections comprising at least one connector member,
the connector comprising:
a body having a through bore from a first end to a second end, threaded engagements at the first end and the second end, and
a connector part in the through bore containing a first connection facing the first end of the through bore and a second connection facing the second end of the through bore,
the first connection comprising, for each connector member of the first connector, a connection member complementary to the connection member of the first connection, the second connection comprising, for each connector member of the second connector, a connection member complementary to the connection member of the second connection.

15. The connector of claim 14, in which the body comprises a metallic material, such as brass.

16. The connector of claim 14, in which the connector part is positioned within the through bore of the body and fills the entire cross section of the through bore along a portion of a length of the through bore.

17. The connector of claim 14, in which the connector part consists of a single body supporting the first connection and the second connection.

18. The connector of claim 17, in which the single body is a plastic insert and the first connection and the second connection comprise pins overmoulded in the plastic insert.

19. The connector of claim 14, in which the connector part acts to seal the through bore.

20. (canceled)

21. A method of installing a coupling, the method comprising:
fitting a first connector part through an orifice in a surface of a housing of an electrical apparatus and a mounting it on that surface, the first connector part having a body having a through bore and a first connection part having a termination for at least one conductor, and a connection member for each termination;
connecting an electrical connection of the electrical apparatus to each termination;
terminating a cable in a second connector part comprising a body having a through bore, a second connection part having a connection member complementary to each connection member of the first connector part so that the connection members of the first and second connector parts can engage each other and a termination for a conductor for each connection member of the second connector part, which a conductor of the cable being terminated in each termination; and
connecting the first connector part to the second connector part so as to threadedly engage each other and such that the connection members of the first and second connector parts electrically connect.

22. The method of claim 21, in which the step of terminating the cable in the second connector part comprises clamping armour of the cable in an armour clamp of the second connector part.

23. A connection, comprising:
a connector for connecting to a first connector and a second connector, each of the first and second connections comprising at least one connector member, the connector comprising:
a body having a through bore from a first end to a second end, threaded engagements at the first end and the second end, and
a connector part in the through bore containing a first connection facing the first end of the through bore and a second connection facing the second end of the through bore, the first connector comprising, for each connector member of the first connector, a connection member complementary to the connection member of the first connection, the second connection comprising, for each connector member of the second connector, a connection member complementary to the connection member of the second connection; and
coupled to each of at least one of the first end and the second end, a coupling part selected from a first coupling part, sized and shaped to fit through an orifice in a surface and having a mounting surface for abutting against the surface, and comprising:
a body having a through bore; and
a connector part having a termination for at least one conductor, and a connection member for each termination arranged to engage a complementary connection member of a complementary coupling part;
in which the coupling part has a threaded engagement portion for engaging a complementarily threaded part of the complementary coupling part; and
a second coupling comprising:
a body having a through bore in communication with the through bore of the first part;
a connector part having a at least one connection member each connectable to complementary connection member of a complementary coupling portion and a termination for a conductor for each connection member;
a threaded engagement portion for engaging with a complementary threaded engagement portion of the complementary coupling portion.
